(19) United States
(12) Patent Application Publication
(10) Pub. No.: US 2023/0339539 A1
(43) Pub. Date: Oct. 26, 2023

(54) Alignment of Machine to Install Steering Frame Lock

(71) Applicant: Caterpillar Inc., Peoria, IL (US)

(72) Inventors: Beau James Berning, Naperville, IL (US); Robert Joseph Madera, Lemont, IL (US); Robert A. Scherbinske, Peoria, IL (US); Mark A. Robinson, Davis Junction, IL (US); Jed Brooker, LaSalle, IL (US); Dustin Dale Denning, Chillicothe, IL (US); Robert E. Shockency, JR., Creve Coeur, IL (US)

(73) Assignee: Caterpillar Inc., Peoria, IL (US)

(21) Appl. No.: 17/726,073

(22) Filed: Apr. 21, 2022

(51) Int. Cl. B62D 12/00; E02F 9/20; E02F 9/08

(52) U.S. Cl. CPC B62D 12/00; E02F 9/2087; E02F 9/0841

(57) ABSTRACT

A method for steering alignment calibration of an articulated machine having front and rear frames pivotally connected by an articulation joint to steer the machine may include displaying a steering alignment calibration screen with a target steering angle between the frames and a calculated steering angle. The calculated steering angle may be determined based on a sensed steering angle and a calibration steering angle. The machine is steered until the displayed calculated steering angle is equal to the target steering angle. If an actual steering angle of the machine is not equal to the target steering angle, further steering is performed until the actual steering angle is equal to the target steering angle. The calibration steering angle may be recalculated and stored for future use when the actual steering angle is equal to the target steering angle but the calculated steering angle is not equal to the target steering angle.

### TECHNICAL FIELD

The present disclosure relates generally to articulated machines and, more particularly, to steering alignment calibration and control of articulated machines for operations such as installation of a steering frame lock.

### BACKGROUND

Articulated machines such as, for example, wheeled loaders and site dumpers are machines that use articulation of the body to steer the machine in particular directions. The machine is commonly divided into a front portion and a rear portion that are aligned with one another both vertically and horizontally at a neutral machine position. Such machines may be provided with articulation joints that allow the front portion of the machine to be connected with the rear portion in such a manner that the front and rear portions can articulate relative to one another. Articulation may be described as that movement wherein the front and rear portions move relative to one another in a sideways manner. Steering systems of articulated machines operate to rotate the front portion about the articulation joint to steer the articulated machine. For example, steering cylinders of a steering system may be connected between the front and rear portions and be controlled based on operator steering input to adjust the relative position of the portions about the articulation joint to steer the machine.

Steering of articulated machines may be monitored and at least partially controlled by controllers and sensors of the machine. In U.S. Pat. Appl. Publ. 2020/0173135 by Gentle et al. and published on Jun. 4, 2020, a front frame and a rear frame of a motor grader are articulated relative to one another during operation at a pivotable coupling or linkage. When the front frame and the rear frame are aligned, the motor grader is positioned with a neutral or 0° articulation or steering angle. An operator may monitor the articulation between the front and rear frames via sensors on articulation cylinders that control the angle between the frames. A user interface may allow the operator to select one or more predetermined articulation positions, and a controller may signal actuators coupled to the articulation cylinders to position the articulation cylinders, and thereby position the front frame relative to the rear frame. A control panel display may include an automated operation control screen displaying various input options for automated control or positioning of components of the motor grader. The input options may include performing an automatic turnaround operation wherein the controller controls the articulation cylinder actuators to steer the motor grader in a partial circle to face in the opposite direction.

Certain operations, such as maintenance operations, may require the articulating components of the machine to have a particular relative orientation. For example, some maintenance operations require the articulated machine to be in the neutral or 0° machine position so a steering frame lock can be installed for safety to prevent rotation about the articulation joint while maintenance is performed. Ensuring that the machine is in the correct position to install the steering frame lock or perform other activities may be a trial and error process because the operator may not be able to see the steering frame lock components from the operator cab. After attempting to turn the machine to the desired position, the operator may shut off the machine for safety, exit the cab and inspect the area between the front and rear frames to see if the alignment is proper for the steering frame lock to be attached. If not, the operator returns to the cab, restarts the engine and makes a steering adjustment to hopefully align the frames for attachment of the steering frame lock. Having a second person enter the machine articulation zone to evaluate whether the frames are properly aligned while the operator is in the cab steering the machine may create safety risks that should be avoided.

### SUMMARY OF THE DISCLOSURE

In one aspect of the present disclosure, a method for steering alignment calibration of an articulated machine is disclosed. The articulated machine may include a rear frame and a front frame pivotally connected by an articulation joint to steer the articulated machine. The method for steering alignment calibration may include displaying a steering alignment calibration screen to an operator of the articulated machine, wherein the steering alignment calibration screen may include a target steering angle between the rear frame and the front frame about the articulation joint and a calculated steering angle, and wherein the calculated steering angle is determined based on a sensed steering angle and a calibration steering angle, steering the articulated machine until the calculated steering angle displayed on the steering alignment calibration screen is equal to the target steering angle, determining an actual steering angle of the articulated machine, comparing the actual steering angle to the target steering angle, and steering the front frame toward the target steering angle in response to determining that the actual steering angle is not equal to the target steering angle.

In another aspect of the present disclosure, an articulated machine is disclosed. The articulated machine may include a rear frame, a front frame, an articulation joint pivotally connecting the front frame to the rear frame wherein a steering angle is a relative position of the front frame relative to the rear frame about the articulation joint, a steering system operatively connected between the rear frame and the front frame and operable to rotate the front frame about the articulation joint to adjust the steering angle, a steering position sensor outputting steering position sensor signals indicating a sensed steering angle of the articulated machine, an output device, a memory, and a machine controller operatively connected to the steering position sensor, the output device and the memory. The machine controller may be programmed to determine a first calculated steering angle based on a first sensed steering angle from first steering position sensor signals and a first calibration steering angle stored at the memory and representing a difference between an actual steering angle of the articulated machine and the sensed steering angle, display the first calculated steering angle and a target steering angle at the output device, determine a second calculated steering angle based on a second sensed steering angle from second steering position sensor signals and the first calibration steering angle, and display the second calculated steering angle at the output device in place of the first calculated steering angle as the steering cylinder changes the steering angle.

In a further aspect of the present disclosure, a method for steering alignment of an articulated machine for locking a steering frame lock is disclosed. The steering frame lock may be between a rear frame and a front frame of the articulated machine that are pivotally connected by an articulation joint to steer the articulated machine. The steering frame lock may include a lock link having a first lock link end that is movably connected to the rear frame and a second lock link end that detachably connects to the front frame when the articulated machine is steered to a frame lock steering angle. The method for steering alignment may include displaying a steering frame lock screen to an operator on a display device of the articulated machine, wherein the steering frame lock screen displays the frame lock steering angle and a calculated steering angle, wherein the calculated steering angle is determined by a machine controller of the articulated machine based on a sensed steering angle and a calibration steering angle, and wherein the sensed steering angle and the calculated steering angle are updated as the front frame rotates relative to the rear frame about the articulation joint. The method may further include steering the articulated machine until the calculated steering angle displayed on the steering frame lock screen is equal to the frame lock steering angle, determining whether an actual steering angle of the articulated machine is equal to the frame lock steering angle for connection of the second lock link end, and steering toward the frame lock steering angle in response to determining that the actual steering angle is not equal to the frame lock steering angle.

Additional aspects are defined by the claims of this patent.

### BRIEF DESCRIPTION OF THE DRAWINGS

FIG. 1 is a side view of an articulated machine in which steering alignment calibration and control in accordance with the present disclosure may be implemented;

FIG. 2 is an enlarged view of a right side articulation zone of the articulated machine of FIG. 1;

FIG. 3 is an enlarged view of a portion of a steering frame lock of the articulated machine of FIG. 1;

FIG. 4 is a schematic view of operational and control system components of the articulated machine of FIG. 1 pertaining to steering alignment calibration and control in accordance with the present disclosure;

FIG. 5 is a front view of a display and control device of the articulated machine of FIG. 1;

FIG. 6 is a front view of the display and control device of FIG. 5 displaying a steering frame lock installation screen in accordance with the present disclosure; and

FIG. 7 is a flow diagram of a steering alignment calibration routine in accordance with the present disclosure for the articulated machine of FIG. 1.

### DETAILED DESCRIPTION

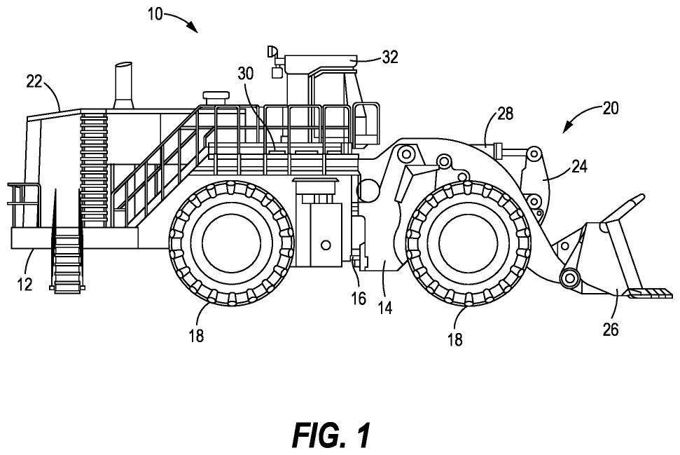

Referring to FIG. 1, an exemplary articulated machine 10 is illustrated in which steering alignment calibration and control in accordance with the present disclosure may be implemented. As shown in the view of FIG. 1, the articulated machine 10 is exemplarily embodied as a wheel loader having a pair of rotatable members, i.e., a rear frame 12 and a front frame 14, that are coupled to each other by an articulation joint 16. Although a wheel loader is illustrated and utilized in the following description, it may be noted that the type of machine used in the present application is merely exemplary in nature and hence, non-limiting of this disclosure. In fact, upon reading the present disclosure, it will be appreciated by persons skilled in the art that steering alignment calibration and control in accordance with the present disclosure can be similarly applied to other types of articulated machines having a pair of rotatable members and an articulation joint coupling the pair of rotatable members. For sake of simplicity and application to other articulated machines, the frames 12, 14 disclosed herein may be referred to as a first rotatable member and a second rotatable member, and denoted using identical reference numerals 12 and 14, respectively.

The frames 12, 14 of the articulated machine 10 may be mounted on wheels 18, and have an implement 20 mounted on the front frame 14. The articulated machine 10 further includes a frame housing 22 of the rear frame 12 that may house, among other components, an engine (not shown) and/or other drive system to propel the articulated machine 10 over various terrain via the wheels 18. The engine can include various power generation platforms, including, for example, an internal combustion engine, whether gasoline, diesel or liquid natural gas (LNG) for example, electric motors and the like.

The implement 20 may be coupled to the front frame 14 through a linkage assembly 24 that is configured to be actuated to articulate a bucket 26 of the implement 20. The bucket 26 of the implement 20 may be configured to transfer material such as soil or debris from one location to another. The linkage assembly 24 can include one or more implement cylinders 28 configured to be actuated hydraulically or pneumatically, for example, to articulate the bucket 26. For example, the linkage assembly 24 can be actuated by the implement cylinders 28 to raise, lower and rotate the bucket 26 relative to front frame 14 of the articulated machine 10.

A platform 30 is coupled to the rear frame 12 and provides access to various locations on the articulated machine 10 for operational and/or maintenance purposes. The articulated machine 10 as illustrated also includes an operator cabin 32 that can be open-air or enclosed, and may be accessed via the platform 30. The operator cabin 32 may include one or more control devices (not shown) such as a joystick, a steering wheel, pedals, levers, buttons, switches and touchscreen displays among other examples of operator input devices. The control devices are configured to enable the operator to control the articulated machine 10 and the implement 20, including articulating the frames 12,14 relative to each other about the articulation joint 16 to steering the articulated machine 10, and performing excavation, mining and/or construction operations. The operator cabin 32 may further include output devices such as display devices, sound sources, light sources, or combinations thereof to provide machine operation information to the operator.

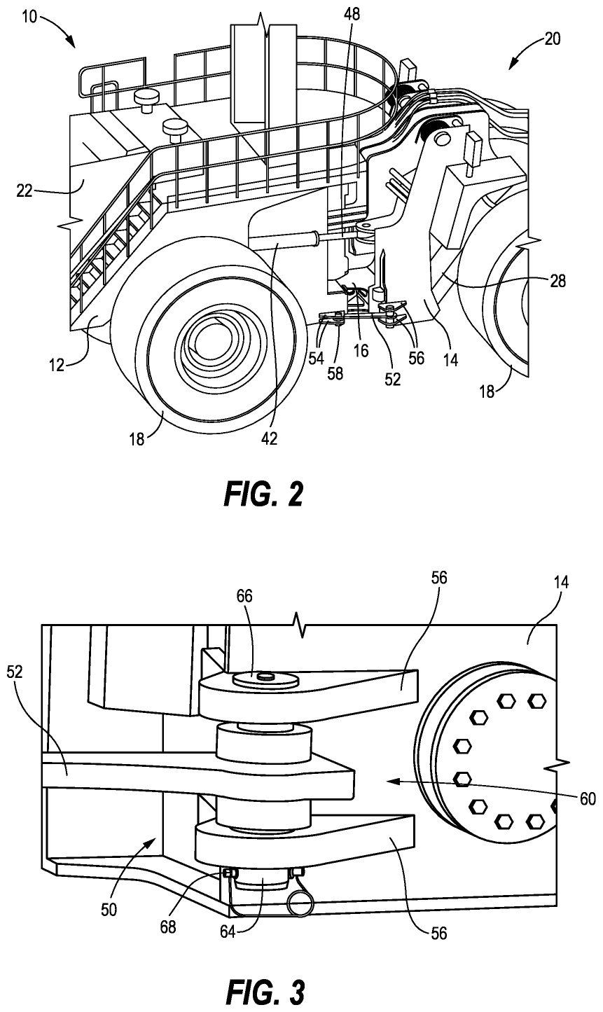

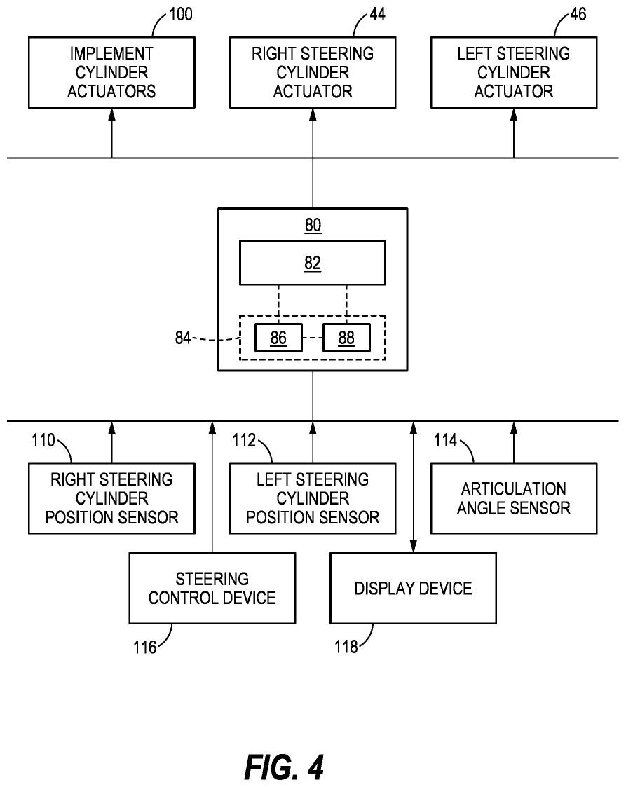

An articulation zone 40 on the right side of the articulated machine 10 between the wheels 18 is illustrated in greater detail in the enlarged view of FIG. 2. The articulation zone 40 on the left side of the articulated machine 10 may have a similar configuration of elements. A portion of the frame housing 22 is removed to reveal a right steering cylinder 42 that is connected between the rear frame 12 and the front frame 14 to control rotation of the front frame 14 about the articulation joint 16. A similar left steering cylinder 42 (not shown) may be connected between the rear frame 12 and the front frame 14 on the left side of the articulated machine 10. The steering cylinders 42 may be hydraulic or pneumatic cylinders having one or more steering cylinder actuators 44, 46 (FIG. 4) that operate to control fluid flow to the steering cylinders 42 to control extension and retraction of cylinder rods 48 to turn the front frame 14 relative to the rear frame 12. Consequently, the steering cylinder actuators 44, 46 may operate to extend the right steering cylinder 42 and retract the left steering cylinder 42, respectively, to turn the front frame 14 to the left, and to retract the right steering cylinder 42 and extend the left steering cylinder 42, respectively, to turn the front frame 14 to the right.

It should be noted that steering via the steering cylinders 42 is exemplary of one type of steering system for the articulated machine 10. Other types of steering systems that may be mechanical, hydromechanical, electromechanical or other appropriate types of systems are know in the art that facilitate rotation of the front frame 14 about the articulation joint 16 relative to the rear frame 12 to steer articulated machines 10. The steering system having the steering cylinders 42 as illustrated and described herein, but those skilled in the art will understand that steering alignment calibration and control in accordance with the present disclosure may be implemented in other articulated machines with other types of steering systems, and such implementations are contemplated by the inventors.

As shown in FIG. 2, the frames 12, 14 may be aligned in a neutral position where the steering angle is 0° and the articulated machine 10 would be propelled in a straight line if the engine is engaged to drive the wheels 18. The neutral position may be a desired position for performing certain maintenance operations on the articulated machine 10. For the safety of maintenance technicians working on the articulated machine 10, it may be desirable to mechanically lock the frames 12, 14 in the neutral position to prevent relative rotation about the articulation joint 16. In the illustrated embodiment, mechanical locking of the frames 12, 14 is provided by a steering frame lock 50 that extends between the frames 12, 14 and can be engaged in the illustrated locked position when the articulated machine 10 is in the neutral position. In the illustrated embodiment, the steering frame lock 50 includes a lock link 52 that extends between rear frame brackets 54 and front frame bracket 56. The lock link 52 may be pivotally mounted to the rear frame brackets 54 at a first lock link end by a pivot pin 58 so that the lock link 52 can rotate from the locked position to a stowed position against the frame housing 22 when the steering frame lock 50 is not locking the frames 12, 14 in the neutral position. While the lock link 52 is illustrated herein as rotating between the stowed and locked position, those skilled in the art will understand that the lock link 52 may have alternative mechanisms operatively coupling the lock link 52 to the rear frame 12 so that the lock link 52 has other paths of motion, such as linear paths, arcuate paths or more complex paths, between the stowed and the locked positions.

An embodiment of the connection of the lock link 52 to the front frame brackets 56 is illustrated in greater detail in FIG. 3. The front frame brackets 56 may be aligned vertically and define a link gap 60 therebetween. A second lock link end of the lock link 52 may fit within the link gap 60 and be positioned between the front frame brackets 56 when the lock link 52 is in the locked position. A locking pin 64 may be inserted through openings of the first lock link end of the lock link 52 and the front frame brackets 56 until a larger diameter head 66 engages the corresponding front frame bracket 56. A cotter pin 68 may be inserted in a hole at the opposite end of locking pin 64 to prevent removal until the steering frame lock 50 is to be unlocked.

Referring now to FIG. 4, exemplary operational components and control system components of the articulated machine 10 pertaining to steering alignment calibration and control in accordance with the present disclosure are illustrated. A machine controller 80 may be provided in the articulated machine 10 to control steering alignment calibration and control among other control functions of the articulated machine 10. The machine controller 80 may include a microprocessor 82 for executing a specified program, which controls and monitors various functions associated with the articulated machine 10. The microprocessor 82 includes a memory 84, such as a read only memory (ROM) 86, for storing a program or programs, and a random access memory (RAM) 88 which serves as a working memory area for use in executing the program(s) stored in the memory 84. Although the machine controller 80 is shown, it is also possible and contemplated to use other electronic components such as a microcontroller, an ASIC (application specific integrated circuit) chip, or any other integrated circuit device.

While the discussion provided herein relates to steering alignment calibration and control, the machine controller 80 is typically configured to control other aspects of operation of other systems of the articulated machine 10. Moreover, the machine controller 80 may refer collectively to multiple control and processing devices across which the functionality of steering alignment calibration and control and other operational systems of the articulated machine 10 may be distributed. For example, in autonomous or semi-autonomous articulated machines 10, portions of the functionality discussed herein may be performed at remote computing devices or monitoring locations that are operatively connected to the machine controller 80 by a communication module (not shown) of the articulated machine 10. The remote computing devices or monitoring locations may be in a centralized location for an enterprise utilizing the articulated machines 10 to perform excavation and material transportation at a worksite. The remote computing devices or monitoring locations may be operatively connected to exchange information as necessary to control and monitor the operation of the articulated machine 10. Other variations in consolidating and distributing the processing of the machine controller 80 as described herein are contemplated as having use in steering alignment calibration and control in accordance with the present disclosure.

The machine controller 80 is operatively connected to the operational components of the articulated machine 10 to the extent that the operational components are controlled by the machine controller 80 or provide data to the machine controller 80 for monitoring and control of the articulated machine 10. Those skilled in the art will be familiar with the exchange of information and control signals between the machine controller 80 and the operational components to control the operation of the operational components and the functioning of the articulated machine 10 without the necessity of further elaboration herein except as necessary to describe steering alignment calibration and control in accordance with the present disclosure.

The machine controller 80 may be configured to transmit control signals to various output devices of the articulated machine 10. Each of the cylinders 28, 42 may be a hydraulic or pneumatic cylinder where the flow of a fluid such as oil, water, air or the like is controlled to extend, retract or lock in place the cylinders 28, 42. Flow control may be performed by control devices or actuators such as control valves that are actuatable in response to control signals to move to corresponding positions for fluid flow to operate the cylinders 28, 42 as commanded. Those skilled in the art will understand that other types of actuators may be implemented that can control movement of the cylinders 28, 42 between extended and retracted positions. Consequently, the actuators for the cylinders 28, 42 may include implement cylinder actuators 100 for the implement cylinders 28, a right steering cylinder actuator 44 for the right steering cylinder 42 and a left steering cylinder actuator 46 for the left steering cylinder 42, that are operatively connected to the machine controller 80. The machine controller 80 may transmit control signals to the implement cylinder actuator 100 to operate the implement cylinders 28 to move the components of the implement 20 and articulate the bucket 26, and to the steering cylinder actuators 44, 46 to operate the steering cylinders 42 to rotate the frames 12, 14 relative to each other about the articulation joint 16. The machine controller 80 may transmit the control signals in response to operator commands input by an operator at input devices within the operator cabin 32 as discussed further below, or in response to automated operation programs for the articulated machine 10 that may be stored in the memory 84 and executed by the microprocessor 82. Of course, where steering alignment calibration and control in accordance with the present disclosure is implemented in articulated machines 10 with other types of steering systems, appropriate actuator devices for those steering systems may be operatively connected to the machine controller 80 to receive appropriate control signals and facilitate steering of the articulated machine 10 in response. Where a particular steering system does not include controlled elements, such as in purely mechanical steering systems, there may be no actuators connected to the machine controller 80.

The machine controller 80 may also be configured to receive signals from various input devices of the articulated machine 10 such as sensors and operator controls. To properly steer the articulated machine 10, it may be necessary to monitor linear positions of the steering cylinders 42 and/or the relative positions of the frames 12, 14 via steering position sensors as the articulated machine 10 is operated. The steering position sensors may output steering position sensor signals that are indictive of the steering angle between the frames 12, 14. In the illustrated embodiment, the right steering cylinder 42 may have a corresponding right steering cylinder position sensor 110 and the left steering cylinder 42 may have a corresponding left steering cylinder position sensor 112. The steering cylinder position sensors 110, 112 may transmit sensor signals to the machine controller 80 that are indicative of the positions of the corresponding steering cylinders 42, and the machine controller 80 may use the sensor signals as inputs to calculate the relative position of the frames 12, 14, which is to say a sensed steering angle of the articulated machine 10.

In such embodiments, the steering cylinder position sensors 110, 112 may be linear position sensors, such as linear variable differential transformer (LVDT) sensors, providing steering cylinder sensor signals indicating an absolute linear position of the associated steering cylinder 42. Triangles formed by the frames 12, 14 and the steering cylinders 42 may have corners located the articulation joint 16 and the pin connections between the steering cylinders 42 and the frames 12, 14. The lengths of the legs of the triangles from the articulation joint 16 to the pin connections is constant, and the length of the leg formed by the corresponding steering cylinder 42 between the pin connections varies as the steering cylinder 42 extends and retracts to rotate the frames 12, 14 about the articulation joint 16. Using the sensor signals from the steering cylinder position sensors 110, 112, the machine controller 80 may calculate the sensed steering angle of the articulated machine 10 based on the geometry of the steering arrangement. If the steering cylinders 42 and the corresponding triangles are symmetrical with respect to the articulation joint 16, the frames 12, 14 may be in the neutral or 0° position when values in the sensor signals indicate that lengths or positions of the steering cylinders 42 are equal. Such sensed steering angle calculations may be performed in real time, or the machine controller 80 may perform lookups in a conversion table stored in the memory 84 that converts values of the steering cylinder sensor signals to corresponding sensed steering angles of the articulated machine 10. Further alternative calculation methods are contemplated.

In alternative embodiments, or in addition to the steering cylinder position sensors 110, 112 for purposes such as redundancy, the articulated machine 10 may include a steering position sensor in the form of an articulation angle sensor 114 operatively connected at the articulation joint 16. The articulation angle sensor 114 may directly detect the relative positions of the frames 12, 14 and output sensor signals indicative of the sensed steering angle of the articulated machine 10. The articulation angle sensor 114 may be a rotary position sensor that measures relative displacement of the frames 12, 14 about the articulation joint 16 in a rotary fashion in the clockwise and counterclockwise directions. Articulation angle sensor signals from the articulation angle sensor 114 may provide a direct measurement of relative positions of the frames 12, 14 that may be directly converted to the sensed steering angle of the articulated machine 10. The steering position sensors described herein are exemplary, and those skilled in the art will understand that any appropriate sensors may be used to detect a parameter indicative of the relative positions of the frames 12, 14 about the articulation joint 16 and transmit steering position sensor signals to the machine controller 80 for conversion into the sensed steering angle of the articulated machine 10.

The machine controller 80 may be operatively connected to input devices within the operator cabin 32 for control of the operations of articulated machines 10 having steering systems that are electromechanical, electrohydraulic, or the like that have controlled elements. The input devices for such steering systems in the operator cabin 32 may include a steering control device 116 that may transmit steering control signals to the machine controller 80 is response to the operator manipulating a steering input device (not shown) to steer the articulated machine 10 during operation. The steering input device may be a steering wheel, joystick(s), tiller or other appropriate input device that may be manipulated by the operator and that operatively connected to the steering control device 116. The steering control device 116 may detect displacement of the steering input device by the operator and convert the displacement into the corresponding steering control signals that are transmitted to the machine controller 80. Upon receiving the steering control signals from the steering control device 116, the machine controller 80 may transmit corresponding control signals to the steering cylinder actuators 44, 46 to operate the steering cylinders 42 to turn the front frame 14 relative to the rear frame 12.

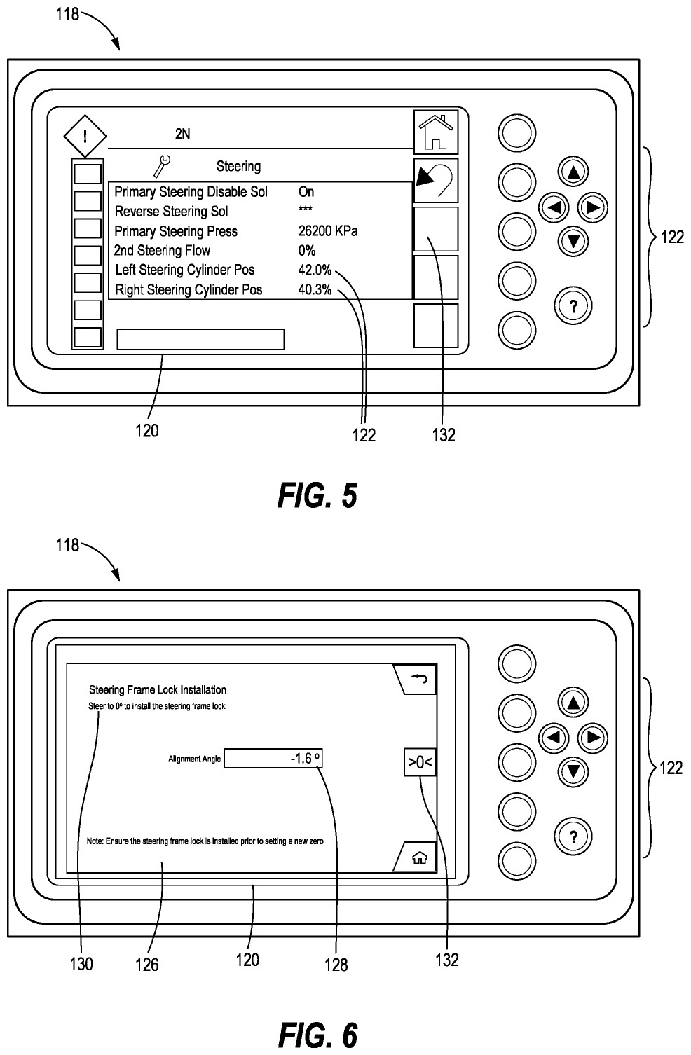

The articulated machine 10 may further include input/output devices in the operator cabin 32 to provide information to the operator and allow the operator to input information for controlling the operation of the articulated machine 10. For example, the operator cabin 32 can include a display device 118 operatively connected to machine controller 80. An example of the display device 118 is illustrated in FIG. 5. The display device 118 may include a display screen 120 configured to display information transmitted to the display device 118 by the machine controller 80 relating to the current operating conditions of the articulated machine 10, such as the current steering cylinder positions 122 to provide an indication of the steering angle of the frames 12, 14. The display screen 120 may be a touchscreen that detects contact by the operator and transmits signals back to the machine controller 80 indicating the position of the operator contact and corresponding input selections made by the operator. The display device 118 may further include additional input devices, such as buttons 124 as shown or other devices such as mouse wheels, joysticks and the like, that may be used to navigate around the display screen 120 and through menus that may be available to display various information and control screens that are available to the operator. Those skilled in the art will understand that the display device 118 is exemplary, and that the functionality for displaying information and making control inputs may be implemented in alternative input/output devices or combinations of input devices and output devices as necessary to implement steering alignment calibration and control in accordance with the present disclosure.

As discussed above, certain relative orientations or steering angles for the frames 12, 14 may be desirable for performing operations by the articulated machine 10 or for performing maintenance operations on the articulated machine 10. Installation of the steering frame lock 50 prior to maintenance as illustrated and described above is one example where a certain steering angle is required. The display device 118 may provide information to assist the operator of the articulated machine 10 in steering the frames 12, 14 to the frame lock steering angle, such as a 0° steering angle. FIG. 6 illustrates the display device 118 displaying a steering frame lock screen 126 in accordance with the present disclosure that may assist the operator in steering the articulated machine 10 to the 0° steering angle for locking the steering frame lock 50.

The display device 118 may display menus and input options at the display screen 120 that allow the operator to input selections to navigate to the steering frame lock screen 126. The screen 126 may include a calculated steering angle box 128 in which a current value of the steering angle calculated by the machine controller 80 may be displayed. The calculated steering angle may be derived from the sensor signals from the steering cylinder position sensors 110, 112, the articulation angle sensor 114 or other appropriate sensor as discussed above, and a calibration steering angle as described further below that accounts for differences between the sensed steering angle and the actual steering angle between the frames 12, 14. The operator steers the articulated machine 10 until the displayed calculated steering angle is equal to a target steering angle 130 displayed on the screen 126. Using the convention wherein steering angles to the right are positive and steering angles to the left are negative, the calculated steering angle value of −1.6° in the box 128 may indicate that the steering angle is 1.6° to the left of the frame lock steering angle required to install the steering frame lock 50. Alternative displays may indicate “LEFT” and “RIGHT” or display left and right arrows along with the steering angle to indicate the direction to which the front frame 14 is turned.

Ideally, the calculated steering angle indicated by the sensors 110-114 or other positions sensors and displayed in the box 128 matches the actual steering angle of the front frame 14 relative to the rear frame 12. However, conditions may occur where the calculated steering angle is not equal to the actual steering angle of the articulated machine 10. For instance, the steering cylinders 42 may not be perfectly symmetrical with respect to the articulation joint 16 such that the sensor signals from the steering cylinder position sensors 110, 112 indicate that the steering cylinders 42 have different positions or lengths when the articulated machine 10 is in the neutral or 0° position. Under these conditions, the calculated steering angle displayed in the box 128 of FIG. 6 may indicate that the articulated machine 10 is in the neutral position even though front frame 14 is steered to the right or the left. In such conditions, it may be necessary to calibrate or recalibrate the calibration steering angle so that the calculated steering angle is equal to the actual steering angle.

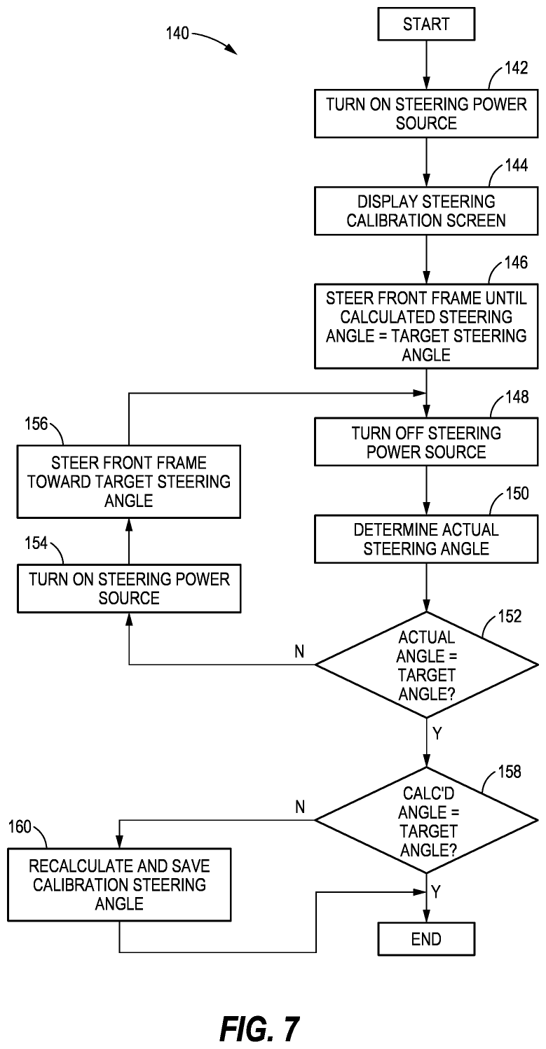

FIG. 7 illustrates an exemplary steering alignment calibration routine 140 in accordance with the present disclosure that may be performed to calibrate the calculated steering angle to the actual steering angle. The routine 140 may be executed prior to leaving a production facility or during initial machine commissioning so that the steering angles are calibrated when the articulated machine 10 is delivered to a customer in the field. However, the routine 140 may be re-executed at any time to ensure that the calculated steering angle presented to the operator matches the actual steering angle of the articulated machine 10. Calibrating steering alignment with the frames 12, 14 in the neutral or 0° position for installation of the steering frame lock 50 is used in the following description of the routine 140 for illustrative purposes. However, those skilled in the art will understand that the steering alignment calibration of the routine 140 may be executed in a similar manner on other display screen and for any other target steering angle to which the articulated machine 10 is to be steered for execution of a particular operation.

The steering alignment calibration routine 140 may begin at a block 142 where an operator of the articulated machine 10 turns on a steering power source of the articulated machine 10. In most articulated machines 10, the steering power source may be the engine that is turned on to drive motors, pumps or the like that provide pressurized fluids manipulated by the steering cylinder actuators 44, 46 to extend and retract the steering cylinders 42 and turn the front frame 14. In other articulated machines 10, motors, pumps or other steering power sources may be operable independent of running the engine such that the steering cylinders 42 may turn the front frame 14 when the engine is off.

After the steering power source is turned on at the block 142, control may pass to a block 144 where the screen 126 or other steering calibration screen is displayed to the operator at a display device such as the display device 118. The machine controller 80 and the display device 118 may exchange information to allow the operator to navigate to the steering calibration screen. This process may include the machine controller 80 determining the sensed steering angle from the position sensor signals and using the calibration steering angle to adjust that value to derive the calculated steering angle. During initial commissioning of the articulated machine 10, the calibration steering angle may have a default value of 0°. The steering calibration screen may be any screen that displays a target steering angle and the calculated steering angle to the operator, and allows the operator to input a calibration selection when the actual steering angle of the articulated machine matches the target steering angle. The steering calibration screen may be exclusively for steering calibration, or may be a screen such as the steering frame lock screen 126 of FIG. 6 that relates to steering angle control for other machine operations but may also include a steering alignment calibration button 132 that may be selected by the operator during the routine 140 as discussed below. Other screens for aligning the steering angle to other specified steering angles for other operations may similarly include the steering alignment calibration button 132.

With the steering calibration screen displayed by the display device 118 at the block 144, control may pass to a block 146 where the operator may displace or otherwise manipulate the steering control device 116 to cause the steering cylinders 42 or other appropriate steering control device of the steering system to turn the front frame 14 toward the target steering angle based on the displayed calculated steering angle. The turn direction and magnitude to get to the actual steering angle should be apparent to the operator from information on the steering calibration screen. In the case of the steering frame lock screen 126 where the target steering angle 130 is 0°, the sensed steering angle displayed in the box 128 indicates that the calculated steering angle is off by 1.6° to the left (“−” sign). Based on this information, the operator will displace the steering control device 116 to attempt to steer the front frame 14 to the right by 1.6°, and will continue to turn the front frame 14 until the calculated steering angle in the box 128 is equal to the target steering angle 130 of 0°. The operator will perform similar steering maneuvers to get the calculated steering angle in the box 128 to match the target steering angle 130 for other steering calibration screens where the target steering angle 130 is not 0°.

After the operator matches the calculated steering angle to the target steering angle at the block 146, control may pass to a block 148 where the operator may turn off the steering power source so that the actual steering position of the articulated machine 10 may be safely inspected. In the example of calibrating the articulated machine 10 based on aligning the frames 12, 14 to lock the steering frame lock 50, a safety risk can exist when the operator or maintenance technician is present in the articulation zone 40 when the engine or the steering power source can cause movement of the articulated machine 10 or its components. Similar safety precautions may be required in other steering calibration scenarios where personnel must come into close proximity of the articulated machine 10 to determine the actual steering angle.

With the engine or steering power source turned off or otherwise disabled for safety at the block 148, control may pass to a block 150 where the articulated machine 10 is inspected to determine the actual steering angle of the articulated machine 10. In some implementations, the frames 12, 14 may have markings or other alignment indicators applied thereto. The articulated machine 10 may be determined to be aligned at the target steering angle when the alignment indicators are aligned. Otherwise, further steering adjustment is required. In the case of the steering frame lock 50, alignment of the articulated machine 10 at the target steering angle may be evaluated by attempting to lock the steering frame lock 50 with the lock link 52 disposed between the front frame brackets 56 and receiving the locking pin 64. If the locking pin 64 cannot be inserted, the frames 12, 14 are not yet aligned at the target steering angle.

After the actual steering angle of the articulated machine 10 is determined by inspection or otherwise at the block 150, control may pass to a block 152 where the actual steering angle is compared to the target steering angle. If the actual steering angle is not equal to the target steering angle, control may pass to a block 154 where the operator may reenter the operator cabin 32 and restart the engine or steering power source, and then to a block 156 where the operator may manipulate the steering control device 116 to turn the front frame 14 toward the target steering angle. The operator may estimate the amount of turning necessary to move the front frame 14 to the target steering angle. As the operator steers the front frame 14, the machine controller 80 updates the calculated steering angle displayed in the box 128 as sensor signals are received from the sensors 110-114. During this time, the difference between the displayed calculated steering angle and the target steering angle should increase. After the operator adjusts the steering angle at the block 156, control passes back to the block 148 where the operator may again turn off the steering power supply and to the block 150 where the operator may again inspect the articulated machine 10 to determine the actual steering angle of the articulated machine 10.

If the actual steering angle is equal to the target steering angle at the block 152 after initially steering the articulated machine 10 to the target steering angle at the block 146 or further adjusting the steering angle at the block 156, control may pass to a block 158 to evaluate whether the calculated steering angle is equal to the target steering angle. If the calculated steering angle is equal to the target steering angle as may be case after steering the articulated machine 10 at the block 146, then the steering alignment is accurately calibrated and the routine 140 may terminate. If the calculated steering angle is not equal to the target steering angle as should be the case when further steering was executed at the block 156 to arrive at the target steering angle, then control may pass to a block 160 where the calibration steering angle may be recalculated and stored by the machine controller 80.

Recalculation of the calibration steering angle may occur when the operator touches the calibration button 132 on the display device 118 to transmit calibration execution signals causing the machine controller 80 to the recalibrate the steering alignment. In response to receiving the calibration execution signals, the machine controller 80 may calculate the calibration steering angle as the difference between the sensed steering angle and the target steering angle. The machine controller 80 may then store the new calibration steering angle in the memory 84. Thereafter, the machine controller 80 may adjust the sensed steering angle determined from the position sensor signals by adding the calibration steering angle to derive the calculated steering angle that should be equal to the actual steering angle. The calculated steering angle may then be transmitted to the display device 118 for display in the box 128 of the screen 126 or similar screens where steering angle calibration may be performed. Once the steering alignment is recalibrated at the block 160, the routine 140 may terminate.

### INDUSTRIAL APPLICABILITY

Steering alignment calibration and control in accordance with the present disclosure may present improvements in efficiency and safety in the operation of articulated machines 10. After steering alignment calibration of the articulated machine 10 is performed at the production facility or during initial commissioning of the articulated machine 10 to account for errors due to tolerances in manufacturing the articulated machine 10, operators in the field may be able to accurately steering the articulated machine 10 to target steering angles via the steering frame lock screen 126 or other similar steering screens instead of relying on other methods such as the use of landmarks like handrails, linkages, platforms and the like to steer the machine 10 to a target steering angle. This can eliminate time consuming iterative processes such as the operator turning the frames 12, 14, shutting down the machine, the operator or another person evaluating the steering angle and making small steering movements until the machine 10 is aligned at the target steering angle. This can also eliminate unsafe live work situations where a second person may enter the articulation zone 40 to evaluate the steering angle while the machine 10 is running.

Steering alignment calibration and control in accordance with the present disclosure may have further application in other implementations of articulated machines 10. For example, the calibration steering angle and the calculated steering angle derived by the machine controller 80 may be utilize to ensure accurate steering of the articulated machine 10 where the on-board operator is replaced with remote control of the articulated machine 10 either by a remote operator or by an autonomous machine control program. The articulated machine 10 could be dispatched to a service area and automatically set to steer the calculated steering angle to the target steering angle, such as the target steering angle for aligning the steering frame lock 50. Of course, steering alignment calibration and control in accordance with the present disclosure has application in manual and automated control of the articulated machine 10 to steer to other steering angle during normal operation and for other maintenance activities such as cylinder replacement, brake replacement and the like.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A method for steering alignment calibration of an articulated machine having a rear frame and a front frame pivotally connected by an articulation joint to steer the articulated machine, the method for steering alignment calibration comprising:
displaying a steering alignment calibration screen to an operator of the articulated machine, wherein the steering alignment calibration screen includes a target steering angle between the rear frame and the front frame about the articulation joint and a calculated steering angle, and wherein the calculated steering angle is determined based on a sensed steering angle and a calibration steering angle;
steering the articulated machine until the calculated steering angle displayed on the steering alignment calibration screen is equal to the target steering angle;
determining an actual steering angle of the articulated machine;
comparing the actual steering angle to the target steering angle; and
steering the front frame toward the target steering angle in response to determining that the actual steering angle is not equal to the target steering angle.

2. The method for steering alignment calibration according to claim 1, comprising:
comparing the calculated steering angle to the target steering angle in response to determining that the actual steering angle is equal to the target steering angle; and
recalculating the calibration steering angle in response to determining that the calculated steering angle is not equal to the target steering angle.

3. The method for steering alignment calibration according to claim 2, wherein the sensed steering angle is determine based on steering position sensor signals from steering position sensors that are indictive of the actual steering angle, and wherein the calculated steering angle is determine by adjusting the sensed steering angle by the calibration steering angle.

4. The method for steering alignment calibration according to claim 3, wherein adjusting the sensed steering angle comprises adding the calibration steering angle to the sensed steering angle.

5. The method for steering alignment calibration according to claim 3, wherein recalculating the calibration steering angle comprises subtracting the sensed steering angle from the target steering angle.

6. The method for steering alignment calibration according to claim 1, comprising turning off a steering power source before determining the actual steering angle.

7. The method for steering alignment calibration according to claim 1, comprising repeating determining the actual steering angle, comparing the actual steering angle to the target steering angle, and steering toward the target steering angle until the actual steering angle is equal to the target steering angle.

8. An articulated machine, comprising:
a rear frame;
a front frame;
an articulation joint pivotally connecting the front frame to the rear frame wherein a steering angle is a relative position of the front frame relative to the rear frame about the articulation joint;
a steering system operatively connected between the rear frame and the front frame and operable to rotate the front frame about the articulation joint to adjust the steering angle;
a steering position sensor outputting steering position sensor signals indicating a sensed steering angle of the articulated machine;
an output device;
a memory; and
a machine controller operatively connected to the steering position sensor, the output device and the memory, the machine controller being programmed to:
determine a first calculated steering angle based on a first sensed steering angle from first steering position sensor signals and a first calibration steering angle stored at the memory and representing a difference between an actual steering angle of the articulated machine and the sensed steering angle,
display the first calculated steering angle and a target steering angle at the output device,
determine a second calculated steering angle based on a second sensed steering angle from second steering position sensor signals and the first calibration steering angle, and
display the second calculated steering angle at the output device in place of the first calculated steering angle as the steering system changes the steering angle.

9. The articulated machine according to claim 8, wherein the articulated machine comprises an input device operatively connected to the machine controller, and wherein the machine controller is programmed to:
detect a steering angle calibration input at the input device;
determine a second calibration steering angle in response to the steering angle calibration input that is equal to the difference between the target steering angle and the second sensed steering angle;
store the second calibration steering angle in the memory in place of the first calibration steering angle;
determine a third calculated steering angle based on the second sensed steering angle and the second calibration steering angle; and
display the third calculated steering angle at the output device in place of the second calculated steering angle.

10. The articulated machine according to claim 8, wherein the steering system comprises a steering cylinder operatively connected between the rear frame and the front frame and having a steering cylinder actuator operable to cause the steering cylinder to extend and retract to adjust the steering angle, wherein the articulated machine comprises an input device, wherein the machine controller is operatively connected to the steering cylinder actuator and the input device, and wherein the machine controller is programmed to:
receive steering control signals from the input device indicating a direction to steer the articulated machine; and
actuate the steering system in response to the steering control signals to steer the articulated machine in the direction indicated by the steering control signals.

11. The articulated machine according to claim 10, wherein the steering position sensor comprises a steering cylinder position sensor that detects a linear position of the steering cylinder, and wherein the machine controller is programmed to convert a length of the steering cylinder indicated by the steering position sensor signals from the steering cylinder position sensor into the sensed steering angle.

12. The articulated machine according to claim 8, wherein the steering position sensor comprises articulation angle sensor that detects an angular position of the front frame relative to the rear frame about the articulation joint, and wherein the machine controller is programmed to convert the angular position of the front frame indicated by the steering position sensor signals from the articulation angle sensor into the sensed steering angle.

13. The articulated machine according to claim 8, comprising a steering frame lock having a lock link having a first lock link end that is movably connected to the rear frame and a second lock link end that detachably connects to the front frame, wherein the lock link moves between a stowed position and a locked position wherein the second lock link end is aligned for connection to the front frame.

14. The articulated machine according to claim 13, wherein the target steering angle is equal to a frame lock steering angle at which the second lock link end can be connected to the front frame.

15. A method for steering alignment of an articulated machine for locking a steering frame lock between a rear frame and a front frame of the articulated machine that are pivotally connected by an articulation joint to steer the articulated machine, wherein the steering frame lock includes a lock link having a first lock link end that is movably connected to the rear frame and a second lock link end that detachably connects to the front frame when the articulated machine is steered to a frame lock steering angle, the method for steering alignment comprising:
displaying a steering frame lock screen to an operator on a display device of the articulated machine, wherein the steering frame lock screen displays the frame lock steering angle and a calculated steering angle, wherein the calculated steering angle is determined by a machine controller of the articulated machine based on a sensed steering angle and a calibration steering angle, and wherein the sensed steering angle and the calculated steering angle are updated as the front frame rotates relative to the rear frame about the articulation joint;
steering the articulated machine until the calculated steering angle displayed on the steering frame lock screen is equal to the frame lock steering angle;
determining whether an actual steering angle of the articulated machine is equal to the frame lock steering angle for connection of the second lock link end; and
steering toward the frame lock steering angle in response to determining that the actual steering angle is not equal to the frame lock steering angle.

16. The method for steering alignment according to claim 15, comprising repeating determining whether the front frame is in position and steering toward the frame lock steering angle until the actual steering angle is equal to the frame lock steering angle.

17. The method for steering alignment according to claim 16, comprising:
causing the machine controller to determine an updated calibration steering angle if the calculated steering angle is not equal to the frame lock steering angle when the front frame is in position for connection of the second lock link end, wherein the updated calibration steering angle is a difference between the frame lock steering angle and the sensed steering angle; and
replacing, via the machine controller, the calibration steering angle with the updated calibration steering angle in a memory of the articulated machine for use in determining the calculated steering angle.

18. The method for steering alignment according to claim 15, wherein the sensed steering angle is determine based on steering position sensor signals from steering position sensors of the articulated machine that are indictive of the actual steering angle, and wherein the calculated steering angle is determine by adjusting the sensed steering angle by the calibration steering angle.

19. The method for steering alignment according to claim 18, wherein adjusting the sensed steering angle comprises adding the calibration steering angle to the sensed steering angle.

20. The method for steering alignment according to claim 15, comprising turning off a steering power source of the articulated machine before determining the actual steering angle of the articulated machine.
